(19) United States
(12) Patent Application Publication
(10) Pub. No.: US 2017/0046178 A1
(43) Pub. Date: Feb. 16, 2017

(54) SYSTEM AND METHOD FOR PROVIDING A USER COGNITIVE LOAD SERVICE

(71) Applicant: PCMS Holdings, Inc., Wilmington, DE (US)

(72) Inventor: Mona Singh, Cary, NC (US)

(21) Appl. No.: 15/306,663

(22) PCT Filed: Apr. 20, 2015
(86) PCT No.: PCT/US15/26694

§ 371 Date: Oct. 25, 2016

Related U.S. Application Data
(60) Provisional application No. 61/985,139, filed on Apr. 28, 2014.

(51) Int. Cl. G06F 9/44; G06F 3/01; G06F 3/0488

(52) U.S. Cl. CPC G06F 9/4443; G06F 3/04886; G06F 3/013; G06F 3/017

(57) ABSTRACT

Systems and methods for a user cognitive load service are described. A cognitive load service runs on a user computing device such as a smart phone. A subscribing application on the device sends a subscription request to the cognitive load service, where the subscription request identifies a set of one or more focus applications. The cognitive load service generates a cognitive load score of the user based on the user's interaction with the device with respect to the focus applications. The service periodically sends the cognitive load score to the subscribing application. The subscribing application adjusts its user interface based on the cognitive load score.

### CROSS-REFERENCE TO RELATED APPLICATIONS

The present application is a non-provisional filing of, and claims benefit under 35 U.S.C. §119(e) from, U.S. Provisional Patent Application Ser. No. 61/985,139, filed Apr. 28, 2014, incorporated herein by reference in its entirety.

### BACKGROUND

The quality of a user's interaction with an application on a computing device such as a wearable computer, mobile phone, desktop computer, laptop computer, or vehicle-based computer can be affected by the extent to which the user is distracted from the application, for example by other applications on the computing device or by external activities such as walking or driving.

### SUMMARY

The present disclosure provides systems and methods for providing a cognitive load service that can be employed by one or more applications on a user's computing device.

In some embodiments, a method is provided for computing and providing a user cognitive load score by continually receiving and storing inputs from input components indicating the user's physical interactions. Exemplary inputs include character-by-character text entry, orientation of the user device, and inputs from the user device regarding the environmental context, such as the GPS position of the device. Other inputs that may be used include inputs from an application manager indicating the changing state of the applications being used by the user, such as which fields (e.g. “To”, “Body”) the user has entered into a compose screen of a messaging application, or whether the user is updating his or her status on a social media application.

A cognitive load service may determine the short-term usage pattern for each application that associates the user's physical interactions and environmental context with the application state. For example, the service may determine that the user has been attempting to update his status when he is moving at walking speed, whereas the user does not normally update his status while moving at walking speed. Such a departure from normal states may indicate a high cognitive load. In another example, the cognitive load service may determine that there is a high cognitive load when the user is holding the phone with one hand and tapping in text slowly, particularly when the user's gaze is frequently away from the device.

In general, the cognitive load service may determine that the pattern of the user's interactions in a recent period (e.g., over the preceding five minutes) are different from a pattern of the user's interactions over a longer period (e.g., over the preceding week). A cognitive load score may be based on a discrepancy between the short-term and long-term usage patterns for the current application. The cognitive load service may provide a cognitive load score to any subscribing application. A subscribing application may identify certain focus applications with respect to which it intends to receive a cognitive load score. The subscribing application may modify its user interface based on the cognitive load score. For example, if the cognitive load score is above a particular threshold, the application may display larger user interface buttons on a touch screen. In some embodiments, the application may require additional confirmation steps before executing certain commands when the cognitive load score is above a threshold.

### BRIEF DESCRIPTION OF THE DRAWINGS

FIG. 1 is a block diagram of a wireless transmit/receive unit (WTRU) that may be employed as a user device in some embodiments.

FIG. 2 is a block diagram of a cognitive load service.

FIG. 3 is a flow chart illustrating interaction between an application and a cognitive load service in an exemplary embodiment.

FIG. 4 is a flow chart illustrating interaction between an application and a cognitive load service in an exemplary embodiment.

FIG. 5 is a functional block diagram illustrating components of a cognitive load system implemented on a user device.

FIG. 6 is a flow chart illustrating operation of a cognitive load determination logic in some embodiments.

### DETAILED DESCRIPTION

The exemplary systems and methods described herein are designed such that an application's interaction with a user takes into account the user's current cognitive load. The systems and methods herein operate to determine a user's cognitive load so that adaptive applications can take advantage of the knowledge of the cognitive load to support intelligent interaction with the user.

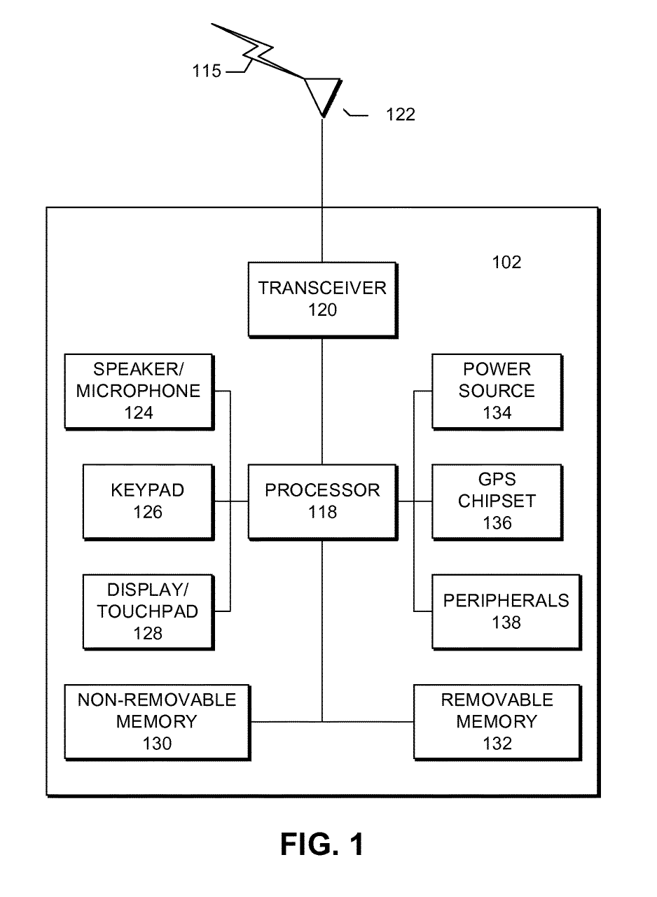

In some embodiments, the systems and methods described herein may be implemented in a wireless transmit receive unit (WTRU), such as WTRU 102 illustrated in FIG. 1. As shown in FIG. 1, the WTRU 102 may include a processor 118, a transceiver 120, a transmit/receive element 122, a speaker/microphone 124, a keypad 126, a display/touchpad 128, a non-removable memory 130, a removable memory 132, a power source 134, a global positioning system (GPS) chipset 136, and other peripherals 138. It will be appreciated that the WTRU 102 may include any sub-combination of the foregoing elements while remaining consistent with an embodiment. The WTRU may communication to nodes such as, but not limited to, base transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1 and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a node over the air interface 115. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115 from a base station and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

The embodiments described herein, whether implemented on WTRU 102 or other computing device, support adaptive applications that take into account a user's cognitive load. For example, in some embodiments, if a user is lightly cognitively loaded, the application displays rapid actions taken with short cuts to improve the user's productivity. However, if the user is cognitively over-loaded, the application interface makes it more difficult for the user to make serious mistakes. For example, the application takes steps to prevent mistakes in the event of a high cognitive load by, for example, asking for verification on important actions. In some embodiments, an intelligent application operates to withhold minor notifications when a user is over-loaded but to present all notifications when the user is not over-loaded. In another embodiment, error-checking features such as a spell checker are employed more aggressively under circumstances of high cognitive load.

In some embodiments, a method is provided for operating a service on a device to determine the cognitive load of a user based on the user's interaction with the device with respect to each application. The cognitive load is then made available by the service to the current application. In some embodiments, the cognitive load is also made available to other subscribing applications.

The embodiments described herein make use of the principle that the level of cognitive load being experienced by a user of an application has an effect on the user's patterns of interaction with the application.

In some embodiments, a user's interactions on a device are recorded and analyzed for both long-term and short-term properties. The user's short-term interactions are compared to the user's long-term interactions to determine to what extent the user is cognitively loaded. Indications include errors made, the speed of the user's interactions, the gaps between successive interactions, and the variability of the gaps between successive interactions.

In some embodiments, a cognitive load service is provided for the use of other applications. Any application can subscribe to the service. When the application receives reports on the user's level of cognitive load, the application modifies the user interface accordingly.

Among other indicia of a user's cognitive load is the orientation of the computing device. For example, a user who is texting while driving would likely hold the device in a manner that is different from the usual manner. For example, a user holding a phone to type an email in a normal environment might use both hands to hold it and his thumbs to type. If the same user is driving, he will likely hold the phone with one hand. The exact orientation of the device will also tend to be different in the two scenarios.

In some embodiments, a cognitive load service determines whether a user is cognitively overloaded based on user interaction parameters. One such parameter is based on time gaps during text entry, such as time gaps between entry of successive characters, words, or fields, corresponding to a speed of text entry. A period of high cognitive overload may be indicated by longer gaps in text entry (for successive characters or words, and in completing various fields such as the “To,” “Address,” or “Subject” fields of an email), when compared to comparable gaps during periods in which the user is not cognitively overloaded. Another parameter from which cognitive load is determined in some embodiments is the variation in gaps in text entry. A wider range of gaps in text entry as listed above, as compared to circumstances where the user is not cognitively over-loaded, may be used as an indication of cognitive overload. Another interaction parameter used in some embodiments as an indication of cognitive overload is a parameter indicating how frequently the user changes the orientation of the device during text entry. More frequent changes in orientation of the device, as compared to circumstances where the user is not cognitively overloaded, serve as an indication of cognitive overload.

An additional interaction parameter used in some embodiments as an indication of cognitive overload is a parameter indicating the level of movement of the device during text entry. Greater movement of the device, as compared to circumstances where the user is not cognitively overloaded, serves as an indication of cognitive overload. In some embodiments, a parameter used to measure cognitive load is a parameter indicating how much the user's gaze is fixated on the application screen. Cognitive overload can be indicated by a gaze that is less fixated on the application screen compared to circumstances where the user is not cognitively over-loaded.

Different sets of parameters may be monitored to determine a level of cognitive load with respect to different applications, or with respect to different types of applications. For example, in the case of a web browsing application, a user may be determined to have a high cognitive load based on a detection of such parameters as longer time gaps between scrolling inputs or longer time gaps between page navigation inputs. Other parameters are measured in some embodiments to identify increased cognitive load include the location of swipes on a screen of the user device, the orientation of the finger when swiping, a different pressure pattern of grip, the distance between the device and the user's eyes, and the orientation of the device.

A determination of which interaction parameters are used in the determination of a user's cognitive load score may depend on the type of application or the type of interaction within an application. For example, when an application is presenting information for the user to read, such as a web page or incoming message, an indication that the user's gaze is frequently tracking away from the device is used in some embodiments as an indication that the user is distracted and results in an increased cognitive load score. However, where the application is awaiting input from a user, such as message text or a status update on a social network application, an indication that the user's gaze is frequently tracking away from the device does not result in an increased cognitive load score, as users often look into the distance while concentrating on composing text.

In general, the cognitive load of a user can be defined with respect to a particular application or set of applications (indicating the extent to which the user is losing focus on this application or set of applications while working on them). This set of applications is referred to herein as focus applications. In some cases, all applications on the device are focus applications. In that case, the cognitive load with respect to the focus applications indicates the extent to which the user is losing focus on all applications on the given device.

In an exemplary implementation of a cognitive load system, consider a user whose device is running four applications: a first finance application (e.g. Fidelity), a second finance application (e.g. Vanguard), a browser (e.g. Chrome), and a navigation application. The Fidelity application is configured to take advantage of the cognitive load service. The Fidelity application sends a subscription request to the cognitive load service. In that subscription request, it can specify which applications are focus applications. There are various possibilities for focus applications.

In one implementation, the Fidelity application is the sole focus application. If the user remains within the Fidelity application, the user's cognitive load is low. However, if the user is switching to other apps or gazing away from the device, that is a sign of increased cognitive load.

In another implementation, the focus applications identified in the subscription request may be the two finance applications, Fidelity and Vanguard. If the user remains within either the Fidelity or the Vanguard applications, the user's cognitive load is low. If the user is switching to the Navigation App or the Chrome App or gazing away from the device, that is a sign of increased load.

In another implementation, all applications are focus applications. If the user is staying within any one application on the device, the determined cognitive score is relatively low. If the user is gazing away from the device, the determined cognitive load score is relatively higher.

In some implementations, an application subscribes for itself as the sole focus application. However, in some implementations an application identifies not only itself, but also identified cooperating applications as focus applications. In some implementations, the application identifies itself plus all other applications in the same domain or category (e.g. finance) as focus applications.

As an example, suppose the Fidelity application subscribes to a cognitive load service and indicates that all finance applications are focus applications. As long as the user stays engaged with one of the finance applications, the user is not considered as being cognitively over-loaded or distracted and the cognitive load score is determined to be low. In effect, the user is treated as performing a high-level “finance” task that involves any combination of the finance applications. This implementation is useful because the user may be performing some financial task that involves going back and forth between multiple finance applications. For example, the user can be checking balances in different accounts as a basis for deciding how much additional funds to invest, what security to sell, or what kind of a risk to take on. Therefore, it is helpful to recognize the user as not being over-loaded in this case and thus to treat the user as being alert to the task. The opposite situation, where the user is not staying within the finance applications, indicates that the user is performing some other task, and may be over-loaded with respect to the finance tasks, so the determined cognitive load score is relatively higher.

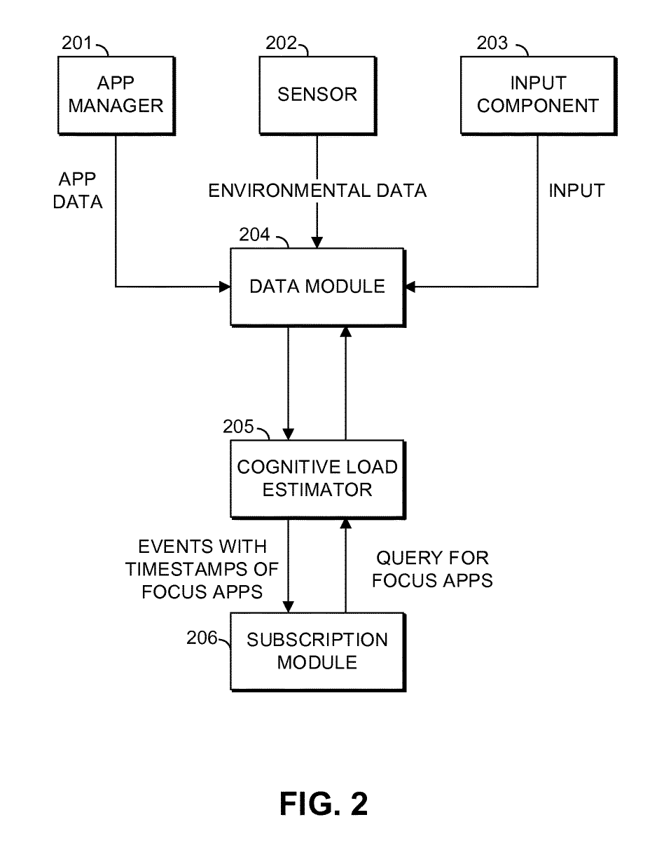

An exemplary architecture of a cognitive load system implemented on a user device is illustrated in the block diagram of FIG. 2. A user device includes one or more input components 203, which may include keyboards, touchpads, touch screens, mice, trackpoints, and joysticks, among others. One or more sensors 202 are provided, which may include a camera pointed toward the user, accelerometers, gyroscopes, GPS receivers, or other environmental sensors, among other examples. The user device includes an application manager 201 that tracks the current state of each application.

The user device is provided with a data module 204, which captures data from which cognitive load is determined. The data module 204 receives observations from input components, sensors, and the application manager, and stores them along with timestamps. The timestamp of an event describes when it occurs. The timestamp may be a full timestamp in some standard notation such as UTC or could be relative to when the measurement was last reset. In some embodiments, the events may be captured with a granularity of one second or ten seconds, for example. Events may be cleared from memory after a predetermined period. For example, if the events are being stored for only one week, a timestamp could be used that cycles to zero after one week. The data module stores the observations in a suitable database. In some embodiments, this database is implemented on the user device; however, as an alternative, the database may be implemented externally, e.g. on a web service.

A subscription module 206 stores information regarding subscriptions including, for each subscription, information identifying the subscribing application and information identifying the set of focus applications for that subscription. A cognitive load estimator 205 takes an active subscription, which identifies the focus applications as one or more applications or as all applications, from the subscription module 206 and computes a cognitive load score for the user with respect to the focus applications.

The subscription module 206 maintains subscriptions from any applications on the device that have subscribed to receive the cognitive load score for the user. The subscription module 206 provides the current subscriptions to the cognitive load estimator and accepts cognitive load scores from the cognitive load estimator. The subscription module 206 also interfaces with subscribing applications by accepting their subscriptions and providing them with a cognitive load score on a continuing basis while the subscription is active.

In some embodiments, the data and cognitive load estimator modules are placed on each user device. That is, the user's data regarding the above-mentioned events and application usage is kept on and analyzed on the device. Thus the data is always available on the device and may give some benefit of privacy to the user. In alternative embodiments, the data and cognitive load estimator modules can be placed in a service provider's data center. Thus the data would need to be transmitted to the data center and the cognitive load score retrieved from the data center. A benefit of doing so is that the computing resources are used on the data center and the events from different user devices can be combined and analyzed together, potentially producing superior results. In other embodiments, some recent data may be stored on the user device, but that recent data is periodically synchronized with the data center by downloading the summary statistics from the data center that apply to relevant applications, thereby enabling disconnected operation while benefiting from the data center.

The cognitive load estimator 205 executes the main steps used to calculate a user's cognitive load. The estimator 205 operates by calculating various statistics for a user based on the user's interactions. In some embodiments, the statistics are calculated at all times. A cognitive load score is calculated based on the statistics based on the recent interactions of the user compared with the statistics based on the long-term interactions of the same user, where a higher deviation indicates a higher cognitive load score.

In some embodiments, the cognitive load estimator calculates running statistics (e.g., the mean) of the time elapsed between successive characters, words, fields entered, scrolling actions, page navigations, touchscreen gestures by a user over a long duration, such as one week. The resulting value may be stored in a variable, e.g. the variable “long-entry”. The cognitive load estimator also calculates running statistics (e.g., the mean) of the time elapsed between successive characters, words, fields entered, scrolling actions, page navigations, touchscreen gestures by a user over a short duration, such as five minutes. The resulting value may be stored in a variable, e.g. the variable “short-entry”.

In some embodiments, the cognitive load estimator also calculates running statistics (e.g., the mean) of the time elapsed between successive times when the user's gaze fixates on the application over a long duration, such as one week. The resulting value is stored in a variable, e.g. the variable “long-gaze”. The cognitive load estimator also calculates running statistics (e.g., the mean) of the time elapsed between successive times when the user's gaze fixates on the application over a short duration, such as five minutes. The resulting value may be stored in a variable, e.g. the variable “short-gaze”.

In an exemplary embodiment, the cognitive load score for the user is calculated as the mean of the following numbers:
If short-entry is greater than long-entry, then short-entry minus long-entry divided by short-entry, else zero.
If short-gaze is greater than long-gaze, then short-gaze minus long-gaze divided by short-gaze, else zero.
   That is, in this exemplary embodiment, the user's cognitive score is calculated as

{min[0,(short-entry)−(long-entry))/(short-entry)]+min[0,(short-gaze)−(long-gaze))/(short-gaze)]}/2

In other embodiments, other interaction parameters are used in the determination of the user's cognitive load score. For example, the velocity of the user may be incorporated based on GPS readings over a short duration, such as five minutes. A greater velocity contributes to a greater cognitive load score.

In different embodiments, applications may make use of a cognitive load score in different ways. For example, if a user's cognitive load score is above a threshold, an exemplary social media application withholds or delays status updates received from friends so as not to create further distractions.

In embodiments disclosed herein, applications modify the user interface or interaction modality in accordance with the user's current cognitive load score. For example, predefined actions may be performed based on the level of the user's cognitive load score. In an embodiment, an application turns on spell checking if the user's cognitive load score is above a preset threshold and turns off spell checking if the user's cognitive load score is below the preset threshold. In some embodiments, an application increases the sizes of on-screen buttons if the user's cognitive load score rises above a preset threshold and reduces the size of buttons if the user's cognitive load score falls below the preset threshold.

In some embodiments, for important interactions such as financial transactions, an application introduces certain safeguards after determining that the user's cognitive load score is above a threshold. For example, the application may use a pop-up confirmation request as a prerequisite for completion of financial transactions if the user's cognitive load score is above some preset threshold. The requirement of a pop-up confirmation for financial transactions is removed if the user's cognitive load score falls below a threshold (which may be the same threshold or a lower threshold).

In some embodiments, the cognitive load service is implemented as an Android platform service, which runs in the background and does not itself provide a user interface. Alternatively, the cognitive load service may be implemented as an analogous service on different platforms using different operating systems.

The cognitive load service may be started automatically on a device when it powers up, so that the service is always running before an application needs it. The service may be configured to consider selected inputs that are available on the particular device. For example, the Samsung Galaxy edition of the service may use text entry and gaze; while the iPhone edition of the service may use text entry, gaze, and the accelerometer. The service can implement a broadcast mechanism by which it sends out custom events. The custom event in this case could provide the cognitive load score for the user. The custom event may be generated at set intervals (e.g., 30 seconds) while the user is using the device. A compatible application implements the corresponding broadcast receiver for the custom events.

An application, such as a Fidelity application, subscribes to the cognitive load service by sending a subscription request. In the subscription request, the application provides information such as its own marketplace identifier (such as its public name or identifier on Google Play) and a list of focus applications, e.g. {Fidelity-App, Vanguard-App}. Each of the focus applications is expressed using its marketplace identifier. The cognitive load service then generates the cognitive load score as a custom events according to the focus applications provided by the app in its subscription request.

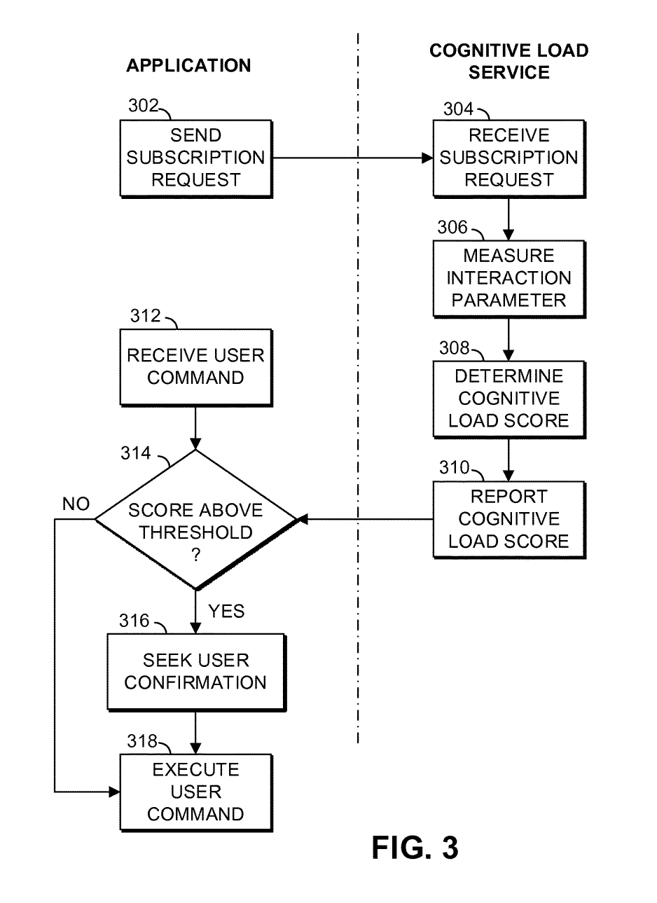

An exemplary method is illustrated in FIG. 3. In step 302, an application sends a subscription request to a cognitive load service, which may be an Android platform service or analogous service. In step 304, the cognitive load service receives the subscription request and stores information regarding the subscription, including information identifying the subscribing application and information identifying any associated focus applications. In step 306, the cognitive load service measures one or more interaction parameters, and in step 308, the cognitive load service determines a cognitive load score based on the interaction parameters. It should be noted that the determined cognitive load score may be different for different subscribing applications. For example, a user repeatedly checking social media on the user device may be determined to have a low cognitive load score with respect to the social media application but a high cognitive load score with respect to, for example, finance-related applications.

In step 310, the cognitive load service reports the cognitive load score to the subscribing application. The subscribing application may make use of the score in various ways. One such implementation is illustrated in FIG. 3. The subscribing application in step 312 has received a command from the user. In step 314, the application determines whether the cognitive load score is above a predetermined threshold. If the cognitive load score is above the threshold, then in step 316, the application requires user confirmation (e.g., using a pop-up) before ultimately executing the user command in step 318. If the cognitive load score is not above the threshold, then the user command is executed (step 318) without requiring confirmation.

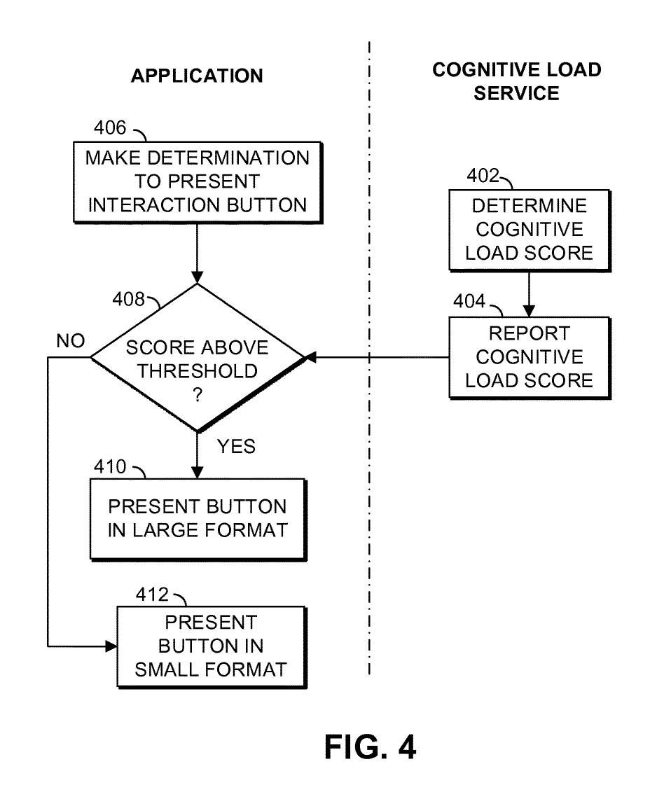

Another use of cognitive load scores by an application is illustrated in FIG. 4. In step 402, the cognitive load service determines a cognitive load score of the user with respect to the application (which may be a subscribing application). In step 404, the service reports the cognitive load score to the application. The application in step 406 has made a determination to present an interaction button on a touch screen of the user device. However, the size of that interaction button will depend on the cognitive load score. In step 408, the user determines whether the cognitive load score is above a threshold. If the cognitive load score is above the threshold, then in step 410, the interaction button is presented in a relatively large format. If the cognitive load score is not above the threshold, then in step 412, the interaction button is presented in a smaller format.

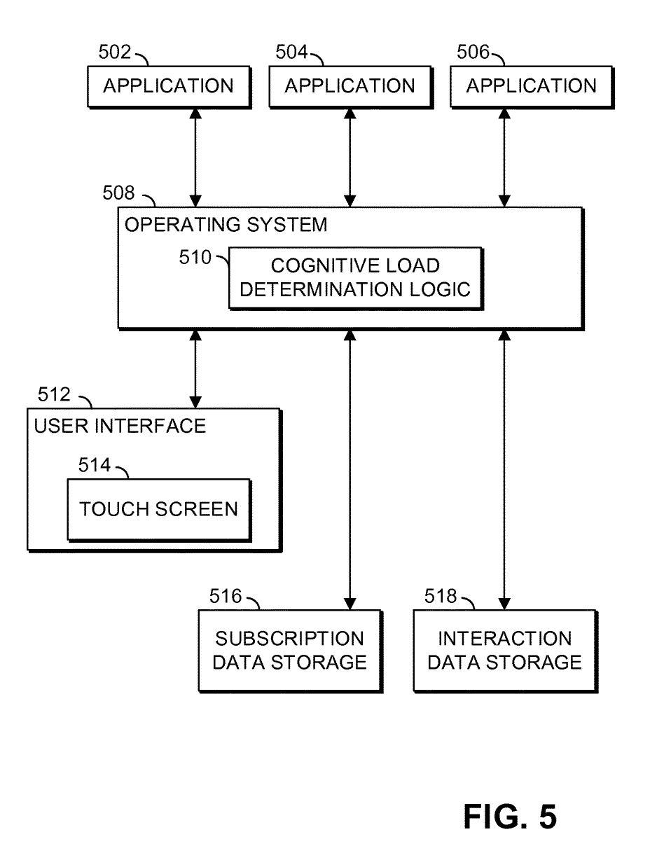

An exemplary architecture of a cognitive load system implemented on a user device is illustrated in FIG. 5. In the embodiment of FIG. 5, the cognitive load service is a service provided by an operating system of the user device. A plurality of applications 502, 504, 506 exchange information with the operating system 508. The operating system includes cognitive load determination logic 510. Applications interact with a user interface 512 (including a touch screen 514) through calls to the operating system 508. The operating system 508 is thus well positioned to measure the interaction parameters described above and to provide those interaction parameters to the cognitive load determination logic 510. The operating system 508 further has access to subscription data storage 516, which stores information identifying those applications that are subscribed to receive cognitive load scores and information on which applications are grouped together as focus applications. The operating system 508 further has access to interaction data storage 518, which stores information on the user's current and historic interaction patterns.

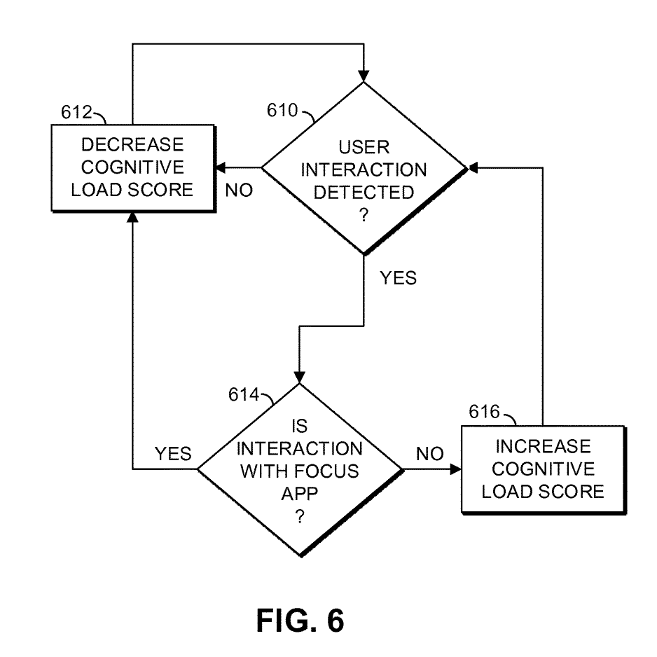

An exemplary operation of cognitive load determination logic is illustrated in the flow chart of FIG. 6. In step 610, the cognitive load determination logic receives an indication that there has been a user interaction, such as text entry. If no user interaction is detected, the cognitive load score is decreased incrementally in step 612. In the absence of any user interaction, steps 610 and 612 may be performed repeatedly (e.g. at preset intervals), resulting in a gradual lowering of the cognitive load score. When a user interaction is detected in step 614, the cognitive load determination logic determines whether the interaction is an interaction with the relevant subscribing application or with focus applications associated with the subscribing application. If so, the cognitive load score may be further decreased incrementally in step 612, as interaction with the subscribing application or associated focus applications indicates a low level of distraction with respect to those applications. However, if the user interaction is not with the subscribing application or its focus applications, then in step 616, the cognitive load score is increased, indicating distraction with respect to the subscribing application.

The flow chart of FIG. 6 is meant to be illustrative. As described throughout this disclosure, many different parameters can be used as contributing factors used to raise or lower the cognitive load score.

In an exemplary method, a subscription request is received from an application on a user device, such as a WTRU. At least one interaction parameter representing an interaction between a user and the user device is measured. A cognitive load score is determined based at least in part on the at least one interaction parameter, and the cognitive load score is provided to the application. The cognitive load score may be provided to the application on a periodic basis. In some embodiments, the subscription request identifies at least one focus application, and the measuring of the interaction parameter includes measuring the extent of a user's interaction with applications other than the identified focus applications.

The cognitive load score may be determined using one or more of several different techniques. For example, the determination of the cognitive load score may include comparing a long-term interaction parameter with a short-term interaction parameter. The determination of the cognitive load score may be based on determining a quantity of errors made by the user.

An interaction parameter may be a parameter indicating a speed of user interactions, a time gap between successive user interactions, an orientation of the user device, a time gap in text entry, speed of text entry, a time gap in entry of text fields, motion of the user device, a level of fixation of the user's gaze on the device, a time gap between scrolling inputs, a time gap in page navigation inputs, a location of swipe inputs on a touch screen of the user device, an orientation of the user's finger during a swiping input, a pressure pattern of the user's grip on the user device, and/or a distance from the user device to the eyes of a user.

In an exemplary embodiment, the cognitive load score is increased by user interaction with applications other than the focus applications. In such an embodiment, the cognitive load score is not increased by user interaction with the focus applications.

In some embodiments, the determination of the cognitive load score includes determining a short-term average of the interaction parameter, determining a long-term average of the interaction parameter, and determining the cognitive load score based on a deviation of the short-term average from the long-term average.

In some embodiments, the measurement of at least one interaction parameter includes storing a plurality of user interaction events and a time stamp associated with each user interaction event. For example, a time stamp associated with an entry of text may be stored.

In another exemplary method, a subscribing application sends a subscription request to a cognitive load service, where the subscription request identifies at least one focus application. The subscribing application receives a cognitive load score of a user with respect to the focus applications. In some embodiments, the cognitive load service is a service of an operating system of the user device. In some embodiments, the subscription request identifies at least two applications as focus applications. In some embodiments, an application can indicated in a subscription that all applications on the user device, or all application of a selected category, are focus applications.

In some embodiments, a subscribing application receives a command from the user and determines whether the cognitive load score is above a threshold. If the cognitive load score is above the threshold, the application seeks confirmation from the user of the command If the cognitive score is not above the threshold, the application executes the user command without requiring confirmation.

In some embodiments, a subscribing application makes a determination to present an interaction button on a touch screen of the user device. The subscribing application makes a determination of whether the cognitive load score is above a threshold. The size of the interaction button depends at least in part on whether the cognitive load score is above the threshold. For example, if the cognitive load score is above the threshold, the interaction button is presented in a relatively larger size, whereas if the cognitive load score is not above the threshold, the interaction button is presented in a relatively smaller size.

In some embodiments, a subscribing application determines whether or not to present a notification based on the cognitive load score. The application receives a notification or otherwise makes a determination that the notification is to be presented. The application determines whether the cognitive load score is above a threshold, and it presents the notification to the user only after determining that the cognitive load score is not above the threshold.

In some embodiments, a subscribing application determines whether or not to implement a spell-check function based on the cognitive load score. The application determines whether the cognitive load score is above a threshold, and the application implements the spell-check function only after determining that the cognitive load score is above the threshold.

In a further exemplary method, a measurement is made of at least one interaction parameter representing an interaction of a user with a user computing device. A cognitive load score of the user is determined based at least in part on the interaction parameter or parameters. After a command is received from the user, for example on a user interface, a determination is made of whether the cognitive load score is above a threshold. If the cognitive load score is above the threshold, confirmation of the command is sought from the user before executing the command. If the cognitive load score is not above the threshold, the command is executed without requiring confirmation.

In another exemplary method, a measurement is made of at least one interaction parameter representing an interaction of a user with a user computing device. A cognitive load score of the user is determined based at least in part on the interaction parameter or parameters. An interaction button is presented on a touch screen of the user computing device, with the size of the interaction button being based at least in part on the cognitive load score.

In some embodiments, a user computing device such as a wireless transmit/receive unit (WTRU) includes a processor and a non-transitory computer-readable medium. The medium stores instructions that are operative, when executed by the processor: to receive a subscription request from an application on the user computing device; to measure at least one interaction parameter of a user with the user device; to determine a cognitive load score of the user based at least in part on the at least one interaction parameter; and to provide the cognitive load score to the application.

In some embodiments, a user computing device such as a wireless transmit/receive unit (WTRU) includes a processor and a non-transitory computer-readable medium. The medium stores instructions that are operative, when executed by the processor, to send a subscription request to a cognitive load service, where the subscription request identifies at least one focus application, and to receive, from the cognitive load service, a cognitive load score of a user with respect to the focus applications.

In some embodiments, the instructions are further operative: to receive a command from the user; to determine whether the cognitive load score is above a threshold; to seek confirmation from the user of the command if the cognitive load score is above the threshold; and to execute the command without confirmation if the cognitive load score is below the threshold.

In some embodiments, the instructions are further operative to determine whether the cognitive load score is above a threshold, and to present an interaction button on a touch screen of the device, where the size of the interaction button depends at least in part on whether the cognitive load score is above the threshold.

In some embodiments, the instructions are further operative: to receive a status update from a social networking service; to determine whether the cognitive load score is above a threshold; and to notify the user of the status update only if the cognitive load score is not above the threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
receiving a subscription request from an application on a user device, wherein the subscription request identifies at least one focus application;
measuring at least one interaction parameter of a user with the user device, wherein the measuring of the interaction parameter includes measuring the extent of a user's interaction with applications other than the at least one focus application;
determining a cognitive load score of the user based at least in part on the at least one interaction parameter;
providing the cognitive load score to the application.

2. (canceled)

3. The method of claim 1, wherein the interaction parameter includes a speed of user interactions.

4. The method of claim 1, wherein the interaction parameter includes a time gap between successive user interactions.

5. The method of claim 1, wherein the interaction parameter includes an orientation of the user device.

6. The method of claim 1, wherein the interaction parameter includes motion of the user device.

7. The method of claim 1, wherein the interaction parameter includes a level of fixation of the user's gaze on the device.

8. The method of claim 1, wherein the cognitive load score is increased by user interaction with applications other than the at least one focus application, and wherein the cognitive load score is not increased by user interaction with the at least one focus application.

9. The method of claim 1, wherein determining the cognitive load score includes:
determining a short-term average of the interaction parameter;
determining a long-term average of the interaction parameter; and
determining the cognitive load score based on a deviation of the short-term average from the long-term average.

10. The method of claim 1, wherein the interaction parameter includes a time gap in text entry.

11. The method of claim 1, wherein the interaction parameter includes a time gap in entry of text fields.

12. A method comprising:
sending, from a first application, a subscription request to a cognitive load service, where the subscription request identifies at least one focus application other than the first application;
receiving, from the cognitive load service, a cognitive load score of a user with respect to the first application and the at least one focus application, the cognitive load score indicating the extent of a user's interaction with applications other than the first application and the at least one focus application; and
adjusting a user interface based on the cognitive load score.

13. The method of claim 12, wherein adjusting the user interface comprises:
receiving a command from the user;
determining whether the cognitive load score is above a threshold; and
seeking confirmation from the user of the command only after determining that the cognitive load score is above the threshold.

14. The method of claim 12, wherein adjusting the user interface comprises:
determining whether the cognitive load score is above a threshold; and
presenting an interaction button on a touch screen, where the size of the interaction button depends at least in part on whether the cognitive load score is above the threshold.

15. The method of claim 12, wherein adjusting the user interface comprises:
presenting an interaction button on a touch screen, where the size of the interaction button depends at least in part on the cognitive load score.

16. The method of claim 12, further comprising:
receiving a notification;
determining whether the cognitive load score is above a threshold; and
presenting the notification to the user only after determining that the cognitive load score is not above the threshold.

17. A user computing device comprising:
a processor;
a non-transitory computer-readable medium storing instructions that are operative, when executed by the processor:
to send a subscription request to a cognitive load service, where the subscription request identifies at least one focus application;
to receive, from the cognitive load service, a cognitive load score of a user with respect to the at least one focus application, the cognitive load score indicating the extent of a user's interaction with applications other than the at least one focus application.

18. The device of claim 17, wherein the non-transitory computer-readable medium further stores instructions operative:
to receive a command from the user;
to determine whether the cognitive load score is above a threshold; and
to seek confirmation from the user of the command if the cognitive load score is above the threshold; and
to execute the command without confirmation if the cognitive load score is below the threshold.

19. The device of claim 17, wherein the non-transitory computer-readable medium further stores instructions operative:
to determine whether the cognitive load score is above a threshold; and
to present an interaction button on a touch screen of the device, where the size of the interaction button depends at least in part on whether the cognitive load score is above the threshold.

20. The device of claim 17, wherein the non-transitory computer-readable medium further stores instructions operative:
to receive a status update from a social networking service;
to determine whether the cognitive load score is above a threshold; and
to notify the user of the status update only if the cognitive load score is not above the threshold.
